(19) United States
(12) Patent Application Publication
(10) Pub. No.: US 2013/0043783 A1
(43) Pub. Date: Feb. 21, 2013

(54) LIGHT EMITTING DEVICE

(71) Applicants: CHIEN-KUO LEE, PINGZHEN CITY (TW); MING-CHE LIN, PINGZHEN CITY (TW); SHIH-PANG CHAO, PINGZHEN CITY (TW)

(72) Inventors: CHIEN-KUO LEE, PINGZHEN CITY (TW); MING-CHE LIN, PINGZHEN CITY (TW); SHIH-PANG CHAO, PINGZHEN CITY (TW)

(21) Appl. No.: 13/400,197

(22) Filed: Feb. 20, 2012

(30) Foreign Application Priority Data
Aug. 18, 2011 (TW) 100129522

(51) Int. Cl. H01J 1/63

(52) U.S. Cl. 313/503

(57) ABSTRACT

A light emitting device of the present invention includes at least: at least more than one blue light chip, at least more than one red light chip and a fluorescent layer overlaid and bonded to the blue light light chip and the red light chip. The fluorescent layer is formed from a uniform mixture of a yellow phosphor and a red phosphor with the addition of a transparent plastic material. At least one portion of the absorbed light source is used to emit a light source with a wave length dissimilar to the wave length of the absorbed light or of the same wave length, thereby achieving the effectiveness to increase the illuminance and color rendering of white light.

### BACKGROUND OF THE INVENTION

(a) Field of the Invention

The present invention relates to a light emitting device, and more particularly provides a light emitting device able to increase the illuminance and color rendering of white light.

(b) Description of the Prior Art

Recent years has seen a trend to advocate green energy, and, based on the concept of saving energy and environmental consciousness, developed countries of the world have equally chosen to gradually replace traditional lighting equipment with white-light light-emitting diodes, because white-light light-emitting diodes have the advantages of being small in size (thereby providing application in the miniaturization of devices), low power consumption (electricity consumption is ⅛ to 1/10 of that of a common light bulb, and ½ that of a daylight lamp), long serviceable life (lasting more than 100,000 hours), low heating value (low heat radiation) and have excellent response rate (enabling high frequency operation). Hence, a considerable number of past insurmountable problems of incandescent lamp bulbs could be resolved, and the white-light light-emitting diode was declared as the new light source of illumination for the 21st century. Moreover, because the white-light light-emitting diode is both power saving and environmentally friendly, thus, it is known as “the green lighting source”.

Blue-light light-emitting diodes (LEDs) matched with a yellow phosphor producing white light is currently a relatively mature technology in the industry. In 1996, the Japanese company Nichia Chemical developed a series of devices able to emit yellow light using yttrium aluminum garnet (Y₃Al₅O₁₂:Ce, YAG:Ce) phosphor in combination with nitride indium gallium (InGaN) blue-color light-emitting diodes, which was able to serve as a high efficiency white-light light source. However, during the process of producing the white light, because a portion of the blue light must play a part in color mixing to obtain the white light, thus, the problem of the color temperature being on the high side occurred. In particular, when operating with a high electric current, the problem of an elevated color temperature was more serious.

In addition, under a high temperature environment, the luminous efficiency of the YAG phosphor decreased as the temperature increased, and the white-light spectrum was almost absent of a red light component, therefore its color rendering index was only around 50-60, resulting in the annoyance of insufficient color rendering when used as a light source for general lighting.

### SUMMARY OF THE INVENTION

The primary objective of the present invention is to provide a light emitting device able to increase the illuminance and color rendering of white light.

In order to achieve the aforementioned objective, a light emitting device of the present invention comprises at least: at least more than one blue light chip, at least more than one red light chip and a fluorescent layer overlaid on the blue light chip and the red light chip. The fluorescent layer is formed from a uniform mixture of a yellow phosphor and a red phosphor with the addition of a transparent plastic material. At least one portion of the absorbed light source is used to emit a light source with a wave length dissimilar to the wave length of the absorbed light or of the same wave length, thereby achieving the effectiveness to increase the illuminance and color rendering of white light.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of flow paths depicting the formation method of a reflecting wall of the present invention.

### DETAILED DESCRIPTION OF THE PREFERRED EMBODIMENTS

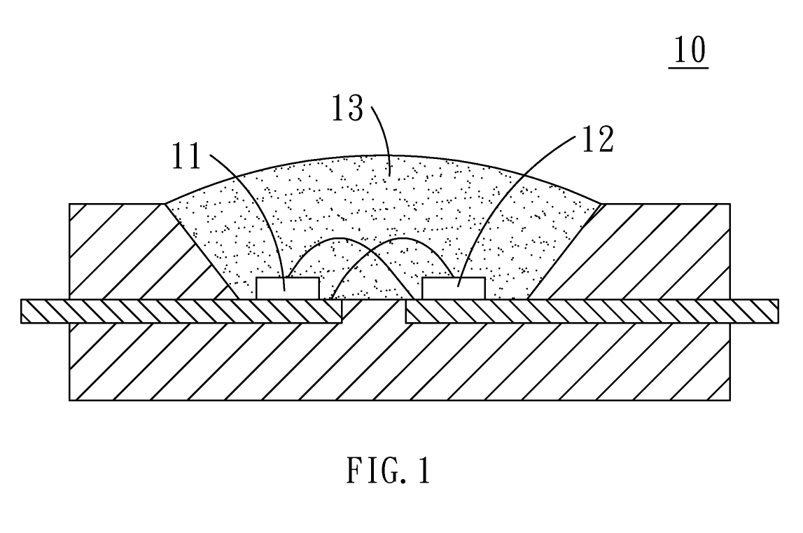

Referring to FIG. 1, the present invention provides a light emitting device 10, comprising at least: at least more than one blue light chip 11, at least more than one red light chip 12 and a fluorescent layer 13. The blue light chip 11 serves as a blue-light light-emitting light source with a wave length of 420-465 nm, the red light chip 12 serves as a red-light light-emitting light source with a wave length of 590-650 nm, and the fluorescent layer 13 is overlaid and bonded on the blue light chip 11 and the red light chip 12. The fluorescent layer 13 is formed from a uniform mixture of a yellow phosphor and a red phosphor with the addition of a transparent plastic material.

The transparent plastic material is 100 percent by weight, the yellow phosphor is 0.1-60 percent by weight, and the red phosphor is 0.1-50 percent by weight. The yellow phosphor can be a lutetium aluminum garnet (LuAG) phosphor, with a choice such as Lu₃Al₅O₁₂:Ce³⁺. The yellow phosphor can be a silicate phosphor, which can be chosen from (Sr, Ca)2SiO₄:Eu²⁺, Ba₂SiO₄:Eu²⁺, SrGa₂S₄, ZnS:Cu⁺, ZnS:Au⁺, ZnS:Al³⁺, (Zn, Cd)S:Ag⁺ or CaS:Ce³⁺ or a combination of the aforementioned. The red phosphor can be a nitride phosphor, which can be chosen from (Ba, Ca, Sr, Eu)₂Si₅N₈₋₂ₓOₓCₓ or AE₂Si₅N₈:RE, in which AE is an alkaline earth element, and RE is a rare earth element, with examples including Ba₂Si₅N₈:Eu²⁺, Ca₂Si₅N₈:Eu²⁺ or Sr₂Si₅N₈:Eu²⁺. The fluorescent layer 13 is used to absorb at least one portion of the light source and emit a light source with a wave length dissimilar to the wave length of the absorbed light or of the same wave length, thereby achieving the effectiveness to increase the illuminance and color rendering of white light.

The following comparative table compares the measured illuminance, color temperature and color rendering between a general light emitting device and the light emitting device of the present invention.

| | | Fluorescent Layer | | | | | | |
|---|---|---|---|---|---|---|---|---|
| | | Transparent | | | | | | |
| | | plastic | LuAG | Silicate | Nitride | | Color | |
| | | material | phosphor | phosphor | phosphor | Illuminance | Temp. | Color |
| No. | Chip | (wt %) | (wt %) | (wt %) | (wt %) | (lm/W) | (K) | Rendering |
| 1 | Blue light | 100 | 10 | 0 | 0 | 93 | 5000 | 64 |
| 2 | Blue light | 100 | 10 | 0 | 0.5 | 88 | 3500 | 72 |
| 3 | Blue light | 100 | 0 | 18 | 0 | 101 | 3000 | 58 |
| 4 | Blue light | 100 | 0 | 18 | 0.5 | 65 | 3000 | 93 |
| 5 | Blue light + | 100 | 5 | 0 | 0.3 | 72 | 2500 | 85 |
| | Red light | | | | | | | |
| 6 | Blue light + | 100 | 10 | 0 | 0.5 | 93 | 2500 | 91 |
| | Red light | | | | | | | |
| 7 | Blue light + | 100 | 25 | 0 | 0.3 | 83 | 2400 | 80 |
| | Red light | | | | | | | |
| 8 | Blue light + | 100 | 35 | 0 | 0.3 | 85 | 2400 | 80 |
| | Red light | | | | | | | |
| 9 | Blue light + | 100 | 45 | 0 | 0.3 | 82 | 2300 | 70 |
| | Red light | | | | | | | |
| 10 | Blue light + | 100 | 0 | 1 | 11 | 79 | 2800 | 70 |
| | Red light | | | | | | | |
| 11 | Blue light + | 100 | 0 | 5 | 0.3 | 79 | 2800 | 90 |
| | Red light | | | | | | | |
| 12 | Blue light + | 100 | 0 | 18 | 0.5 | 92 | 2600 | 90 |
| | Red light | | | | | | | |
| 13 | Blue light + | 100 | 0 | 25 | 0.3 | 94 | 2600 | 80 |
| | Red light | | | | | | | |
| 14 | Blue light + | 100 | 0 | 35 | 0.3 | 93 | 2500 | 70 |
| | Red light | | | | | | | |

From the above table it can be understood that No. 1 and No. 3 used a blue light chip in combination with a phosphor (lutetium aluminum garnet phosphor or silicate phosphor respectively), and although the illuminance of the stimulated light emitted by the white-light light source is high, however, the color temperature is also relatively high and the color rendering is relatively low, resulting in the color presented by an illuminated object being unnatural, and affecting the visual perspective of the human eye. In addition, it is also unable to appropriately display the real color which the illuminated object should present. No. 2 and No. 4 similarly used a blue light chip in combination with a yellow phosphor (lutetium aluminum garnet phosphor or silicate phosphor respectively) and a red phosphor (nitride phosphor), and although the color rendering increased, however, there was a substantial drop in the illuminance, and the color temperature was still high.

No. 5 to No. 14 used the light emitting device of the present invention comprising the blue light chip and red light chip in combination with a yellow phosphor (lutetium aluminum garnet phosphor or silicate phosphor respectively) and a red phosphor (nitride phosphor), resulting in the illuminance being maintained at more than 70 lm/W, with an optimum value of 94 lm/W, the color temperature equally fell below 3000K, and color rendering was able to be maintained at more than 70, with an optimum value of 91, in which No. 6 and No. 12 are preferred embodiments. In the embodiment of No. 6, the preferred amount of the lutetium aluminum garnet phosphor is 10 percent by weight, the preferred amount of the nitride phosphor is 0.5 percent by weight, and the preferred amount of the silicate phosphor in the embodiment of No. 12 is 18 percent by weight, while the preferred amount of the nitride phosphor is 0.5 percent by weight.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A light emitting device, comprising at least:
at least more than one blue light chip;
at least more than one red light chip;
a fluorescent layer, the fluorescent layer is formed from a uniform mixture of a yellow phosphor and a red phosphor with the addition of a transparent plastic material, this fluorescent layer is overlaid and bonded to the blue light chip and the red light chip, the transparent plastic material is 100 percent by weight, the yellow phosphor is 0.1-60 percent by weight, and the red phosphor is 0.1-50 percent by weight.

2. The light emitting device according to claim 1, wherein the yellow phosphor is lutetium aluminum garnet (LuAG) phosphor.

3. The light emitting device according to claim 2, wherein the LuAG phosphor is chosen from Lu₃Al₅O₁₂:Ce³⁺.

4. The light emitting device according to claim 2, wherein the red phosphor is nitride phosphor.

5. The light emitting device according to claim 4, wherein 10 percent by weight of the lutetium aluminum garnet phosphor is preferred, and 0.5 percent by weight of the nitride phosphor is preferred.

6. The light emitting device according to claim 4, wherein the nitride phosphor is chosen from (Ba, Ca, Sr, Eu)₂Si₅N₈₋₂ₓOₓCₓ or AE₂Si₅N₈:RE, in which AE is an alkaline earth element, and RE is a rare earth element.

7. The light emitting device according to claim 6, wherein Ba₂Si₅N₈:Eu²⁺, Ca₂Si₅N₈:Eu²⁺ or Sr₂Si₅N₈:Eu²⁺ is preferred as the nitride phosphor.

8. The light emitting device according to claim 1, wherein the yellow phosphor is silicate phosphor.

9. The light emitting device according to claim 8, wherein the silicate phosphor is chosen from (Sr, Ca)2SiO₄:Eu²⁺, Ba₂SiO₄:Eu²⁺, SrGa₂S₄, ZnS:Cu⁺, ZnS:Au⁺, ZnS:Al³⁺, (Zn, Cd)S:Ag⁺ or CaS:Ce³⁺ or a combination of the above.

10. The light emitting device according to claim 8, wherein the red phosphor is nitride phosphor.

11. The light emitting device according to claim 10, wherein 18 percent by weight of the silicate phosphor is preferred, and 0.5 percent by weight of the nitride phosphor is preferred.

12. The light emitting device according to claim 10, wherein the nitride phosphor is chosen from (Ba, Ca, Sr, Eu)₂Si₅N₈₋₂ₓOₓCₓ or AE₂Si₅N₈:RE, in which AE is an alkaline earth element, and RE is a rare earth element.

13. The light emitting device according to claim 12, wherein Ba₂Si₅N₈:Eu²⁺, Ca₂Si₅N₈:Eu²⁺ or Sr₂Si₅N₈:Eu²⁺ is preferred for the nitride phosphor.
